(19) United States
(12) Patent Application Publication
(10) Pub. No.: US 2026/0060291 A1
(43) Pub. Date: Mar. 5, 2026

(54) ATOMIZER

(71) Applicant: ShenZhen GreenEcigs Technology Limited Company, Shenzhen (CN)

(72) Inventor: Lantian GUO, Shenzhen (CN)

(73) Assignee: ShenZhen GreenEcigs Technology Limited Company, Shenzhen (CN)

(21) Appl. No.: 18/968,110

(22) Filed: Dec. 4, 2024

(30) Foreign Application Priority Data
Aug. 29, 2024 (CN) 202411199431.5

(51) Int. Cl. A24F 1/30; A24F 40/20; A24F 40/46; A24F 40/48; A24F 40/50; H05B 3/06

(52) U.S. Cl. CPC A24F 1/30; A24F 40/20; A24F 40/46; A24F 40/48; A24F 40/50; H05B 3/06; H05B 2203/016

(57) ABSTRACT

An atomizer includes an atomizer body and an atomizer core. The atomizer body is provided with an electric control module and a mounting portion. The atomizer core is connected to the mounting portion and is located outside the atomizer body; the atomizer core is electrically connected to the electric control module, and the atomizer core is configured to extend into an adapter socket of a water filter.

### CROSS-REFERENCE TO RELATED APPLICATIONS

This application claims priority to Chinese Patent Application No. 202411199431.5, filed on Aug. 29, 2024, the entire contents of which are incorporated herein by reference.

### TECHNICAL FIELD

The present application relates to the technical field of electronic cigarettes, and in particular to an atomizer.

### BACKGROUND

In the related art, the atomizer with a water filter has a main body, an air duct, and an adapter from top to bottom. The main body is provided with an atomizer core, which is configured to atomize the smoke material to form smoke. The air duct is hollow inside, configured to connect the atomizer core with the adapter, and transmit the smoke from the atomizer core to the adapter. The adapter is configured to insert the water filter, and has a cavity inside, which can guide the smoke into the water filter. The water filter is configured to filter the incoming smoke.

However, the setting of the air duct and the adapter makes the smoke path longer, which makes the smoke easy to condense during the transmission process, thereby consuming the smoke. In addition, the smoke condensation on the wall can easily block the air duct and the adapter, making it difficult to clean. At the same time, the atomizer core will generate heat during operation, and the heat energy generated will have a greater impact on the main body, so the main body needs to be insulated. In addition, the connection between the main body and the air duct and the adapter is not easy to seal, resulting in poor sealing.

### SUMMARY

The main purpose of the present application is to provide an atomizer, aiming to solve at least one technical problem raised above.

To achieve the above purpose, the present application provides an atomizer, including: an atomizer body and an atomizer core. The atomizer body is provided with an electric control module and a mounting portion. The atomizer core is connected to the mounting portion and is located outside the atomizer body. The atomizer core is electrically connected to the electric control module, and the atomizer core is configured to extend into an adapter socket of a water filter.

In an embodiment, the atomizer core includes a connector, an atomizer seat and a heater; one end of the connector is connected to the atomizer seat, and the other end of the connector is detachably connected to the mounting portion; the heater is installed on the atomizer seat.

In an embodiment, the connector is threadedly connected to the mounting portion.

In an embodiment, a discharge port is provided on a circumference of the atomizer seat, and the discharge port is configured to allow smoke material to be placed in the atomizer seat.

In an embodiment, the atomizer seat is provided with an atomizer material cavity, and the atomizer material cavity is communicated with the discharge port; the atomizer core is provided with an air inlet, and the atomizer material cavity is communicated with an external environment through the air inlet.

In an embodiment, the atomizer seat includes an adapter, a chassis, and at least one connecting portion connecting the adapter and the chassis, and the discharge port is formed in the connecting portion; the adapter is configured to install the connector, and the chassis is configured to install the heater.

In an embodiment, an outer wall of the connecting portion is provided in an arc shape.

In an embodiment, a step surface is provided at a connection between the adapter and the connecting portion.

In an embodiment, in a direction from the adapter to the chassis, the connecting portion is flush with an outer surface of the chassis, and the connecting portion is tapered.

In an embodiment, one connecting portion is provided; one end of the connecting portion is connected to the adapter, and the other end of the connecting portion is connected to the chassis; the discharge port is formed at an outer side of the connecting portion.

In an embodiment, the atomizer core further includes a bottom plate, and the bottom plate is slidably connected to the chassis and is located at a side of the heater away from the connector; and a gap is formed between the bottom plate and the heater.

In an embodiment, a chamber is formed between the bottom plate and the heater, and the atomizer seat is provided with a front side and a rear side opposite to the front side; the connecting portion is provided on the rear side, and a hatch of the chamber is opened toward the front side; a left side and a right side of the hatch are respectively provided with end walls, the end walls are provided from bottom to top and inclined from the rear side to the front side.

In an embodiment, two connecting portions are provided, and the two connecting portions are provided at intervals along a circumference of the atomizer core; one end of each connecting portion is connected to the adapter, and the other end of each connecting portion is connected to the chassis; the discharge port is formed between the two connecting portions.

In an embodiment, the heater includes a heating part and a conductive part connected to the heating part; the heating part is provided at the chassis, and the conductive part is provided at the connecting portion and electrically connected to the electric control module.

In an embodiment, the conductive part is embedded in the connecting portion; or the connecting portion is provided with a socket, and the conductive part is inserted into the socket.

In an embodiment, the material of the atomizer seat is ceramic material.

In an embodiment, the atomizer body includes a rotating part and a main body; the mounting portion is provided at one end of the rotating part, and the other end of the rotating part is rotatably connected to the main body.

In an embodiment, a rotation angle of the rotating part ranges from 0°-180°.

In an embodiment, the atomizer further includes: a protective cover, wherein the protective cover is configured to cover the atomizer core.

In technical solutions of the present application, the atomizer includes an atomizer body and an atomizer core. The atomizer body is provided with a mounting portion. The atomizer core includes a connector and an atomizer seat. One end of the connector is connected to one end of the atomizer seat, and the other end of the connector is connected to the mounting portion. The atomizer core is configured to extend into the adapter socket of the water filter. By connecting the atomizer core to the atomizer body through the connector, the atomizer core is located outside the atomizer body, and when the atomizer is in use, the atomizer core is partially extended into the adapter socket of the water filter. The connection between the atomizer and the water filter does not need to pass through structures such as an air duct or an adapter, thereby shortening the smoke path, so that the smoke will not be lost due to the long path to the water filter. At the same time, the smoke will not condense and adhere to the inner wall of the air duct or the adapter, causing the air duct or the adapter to be blocked. In addition, the atomizer core is located outside the atomizer body, and the heat generated by the atomizer core has no effect on the atomizer body, so there is no need to set up a separate insulation structure to insulate it, saving costs. At the same time, the ventilation of the atomizer core is no longer limited by the size and structure of the atomizer body, and the ventilation volume of the atomizer core can be increased.

### BRIEF DESCRIPTION OF THE DRAWINGS

In order to more clearly illustrate the embodiments of the present application or the technical solutions in the related art, the drawings required for use in the embodiments or the description of the related art will be briefly introduced below. Obviously, the drawings described below are only some embodiments of the present application. For those skilled in the art other drawings can be obtained based on the structures shown in these drawings without creative work.

FIG. 1 is a schematic structural view of an atomizer according to an embodiment of the present application.

FIG. 2 is a schematic structural view of the atomizer after removing the protective cover in FIG. 1.

FIG. 3 is an exploded view of the atomizer in FIG. 2.

FIG. 4 is an exploded view of the atomizer according to another embodiment of the present application.

FIG. 5 is a partial enlarged view of a point A in FIG. 4.

FIG. 6 is a schematic structural view of an atomizer core in FIG. 3.

FIG. 7 is a partial enlarged view of a point B in FIG. 6.

FIG. 8 is an exploded view of the atomizer core in FIG. 6.

FIG. 9 is a schematic structural view of the atomizer core in FIG. 4.

FIG. 10 is an exploded view of the atomizer core in FIG. 9.

FIG. 11 is a schematic structural view of a rotating part of the atomizer at a first rotation angle.

FIG. 12 is a schematic structural view of the rotating part of the atomizer at a second rotation angle.

FIG. 13 is a schematic structural view of the rotating part of the atomizer at a third rotation angle.

FIG. 14 is a schematic structural view of the rotating part of the atomizer at a fourth rotation angle.

FIG. 15 is a schematic structural view of the rotating part of the atomizer at a fifth rotation angle.

FIG. 16 is a schematic structural view of an assembled structure of the atomizer and water filter.

FIG. 17 is a schematic structural view of a separation of the atomizer and the water filter.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that if there is a directional indication (such as up, down, left, right, front, rear) in the embodiments of the present application, the directional indication is only configured to explain the relative positional relationship, movement, etc. of the components in a certain posture (as shown in the drawings). If the specific posture changes, the directional indication will change accordingly.

Besides, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. The meaning of “and/or” appearing in the present application includes three parallel scenarios. For example, “A and/or B” includes only A, or only B, or both A and B. In addition, the technical solutions between the various embodiments can be combined with each other, but they must be based on the realization of those of ordinary skill in the art. When the combination of technical solutions is contradictory or cannot be achieved, it should be considered that such a combination of technical solutions does not exist, nor is it within the scope of the present application.

In the related art, after the atomizer structure for atomizing tobacco material is connected to the rotating part for users to inhale, the atomizer core generates smoke, which needs to pass through the air duct and the adapter in sequence before the smoke is introduced into the rotating part for users to inhale. However, the setting of the air duct and the adapter makes the smoke path longer, which makes the smoke easy to condense, thereby consuming the smoke. In addition, the smoke condensation on the wall can easily block the air duct and the adapter, making it difficult to clean.

The present application provides an atomizer, which is applied to an atomizing device and is detachably connected to the atomizing device. The present application can solve the technical problems that the smoke of the atomizer is easily lost and the air duct is easily blocked.

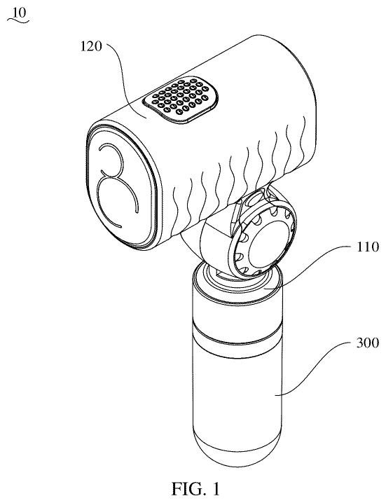

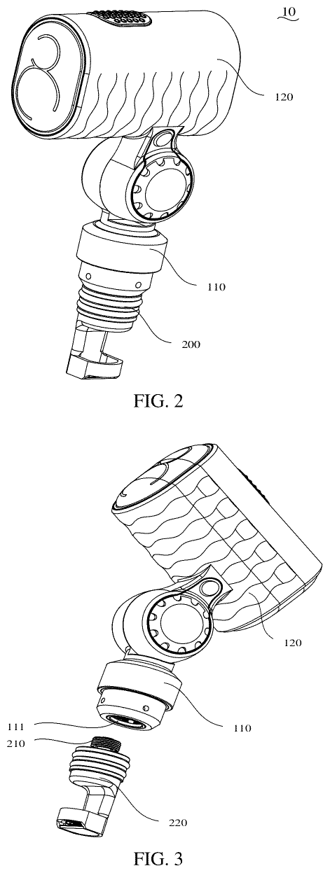

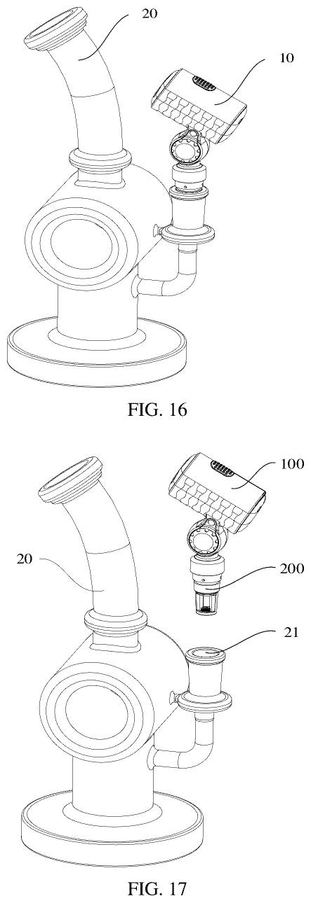

As shown in FIG. 1, FIG. 2, FIG. 16 and FIG. 17, in an embodiment, the atomizer 10 includes an atomizer body 100 and an atomizer core 200; the atomizer body 100 is provided with an electric control module and a mounting portion 111; the atomizer core 200 is connected to the mounting portion 111 and is located outside the atomizer body 100; the atomizer core 200 is electrically connected to the electric control module, and the atomizer core 200 is configured to extend into the adapter socket 21 of the water filter 20.

The atomizer body 100 has a shell, and a mounting chamber is formed in the shell. An electric control module is provided in the mounting chamber, and the electric control module and the atomizer core 200 are electrically connected to control the atomizer core 200 to start or stop through the electric control module. A battery module can also be provided in the mounting chamber, and the battery module and the electric control module are electrically connected to provide power to the atomizer 10. The electric control module can be integrated on a circuit board, and the battery module can also be integrated on the circuit board, which is not limited.

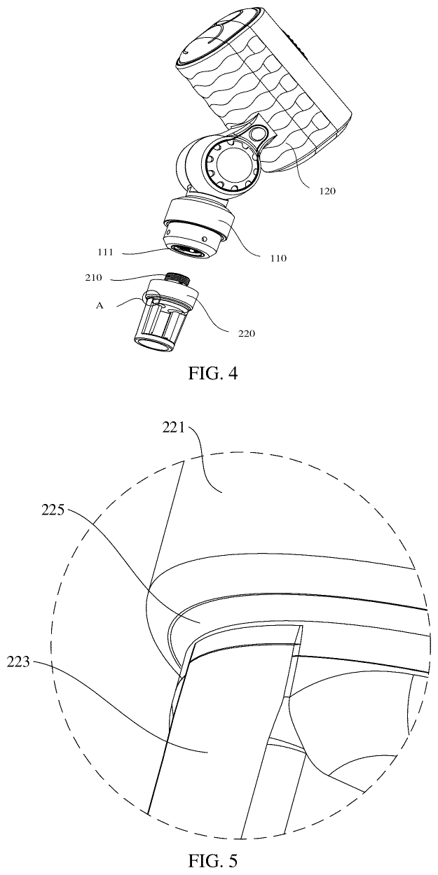

In an embodiment, as shown in FIG. 3 and FIG. 4, the atomizer core 200 is connected to the mounting portion 111, and the atomizer core 200 is located outside the atomizer body 100. On the one hand, it is convenient to connect the atomizer core 200 to the atomizer body 100. On another hand, when the atomizer 10 is connected to the water filter 20, it only needs to ensure that the atomizer core 200 extends into the adapter socket 21 of the water filter 20, thereby eliminating structures such as an air duct or an adapter, shortening the smoke path, and preventing the smoke from being lost due to the long path of smoke reaching the water filter 20. At the same time, the smoke will not condense and adhere to the inner wall of the air duct or the adapter, causing the air duct or the adapter to be blocked.

In an embodiment, the water filter 20 is a device that purifies the smoke generated by the atomizer 10 by physical and chemical means, which can reduce the content of harmful substances in the smoke to a certain extent and improve the smoking experience. When the smoke passes through water, large particles such as tar, dust in the smoke will be blocked by water and deposited, thereby reducing the risk of these harmful substances being inhaled into the human body. Some chemical components in the smoke may undergo chemical reactions when in contact with water, such as dissolution, neutralization, further reducing the content of harmful substances. At the same time, the water filter 20 can also cool the smoke and reduce its pressure, making the inhaled smoke softer and reducing irritation to the respiratory tract. For some smokers, the water filter 20 of electronic cigarettes may be used as an auxiliary tool in the process of quitting smoking, helping to gradually reduce dependence on traditional tobacco. The filter solution in the water filter 20 can not only be an aqueous solution, but also other solutions that can purify smoke, and which is not limited.

In an embodiment, as shown in FIG. 16 and FIG. 17, the water filter 20 is provided with an adapter socket 21 for connecting to the atomizer 10. The atomizer core 200 is inserted into the adapter socket 21. The water filter 20 and the atomizer 10 can be connected through the adapter socket 21, or can be connected together in other ways. The atomizer core 200 can be inserted into the adapter socket 21 of the atomizer 10 as a whole, or only the atomizer seat 220 can be partially inserted into the adapter socket 21. The arrangement may be determined according to the position or structure of the air inlet 240 of the atomizer 10, and which is not limited.

In an embodiment, the atomizer core 200 is extended into the water filter 20 to connect the air outlet channel of the atomizer 10 and the water filter 20. When the user uses the atomizing device, the electronic control module controls the atomizer core 200 to atomize the tobacco material. The smoke generated after atomization will enter the water filter 20 for filtration, and the filtered smoke will flow out from the mouthpiece part of the water filter 20 for the user to inhale. Since the atomizer core 200 extends into the adapter socket 21 of the water filter 20, the smoke generated after atomization will directly enter the water filter 20 for filtration. Different from the related art, in which the atomizer 10 and the water filter 20 need to be connected through an air duct or an adapter, the present application directly extends the atomizer core 200 into the adapter socket 21 of the water filter 20. Therefore, the connection method of the present application is simple and convenient, easy to operate, and easy to clean. At the same time, since there is no air duct or an adapter, the situation of difficult sealing and poor contact between the atomizing core 200 and the atomizer 10 is avoided. Further, there is no other structure between the atomizer core 200 and the water filter 20, thereby shortening smoke path, so that the smoke will not be lost due to the long path. At the same time, the smoke will not condense and adhere to the inner wall of the air duct or the adapter, causing the air duct or the adapter to be blocked. The atomizer core 200 is located outside the atomizer body 100, and the heat generated by the atomizer core 200 has no effect on the atomizer body 100, so there is no need to set up a separate heat insulation structure to perform heat insulation treatment on it, which saves costs. At the same time, the ventilation of the atomizer core 200 is no longer limited by the size and structure of the atomizer body 100, and the ventilation volume of the atomizer core 200 can be increased.

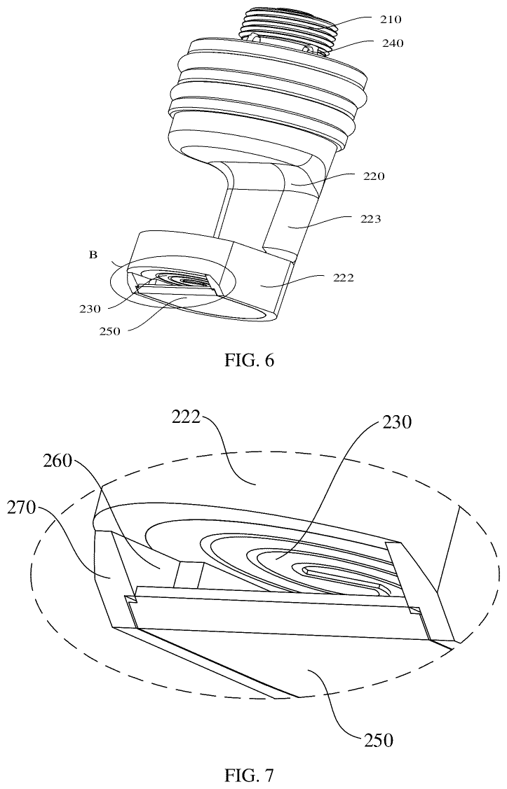

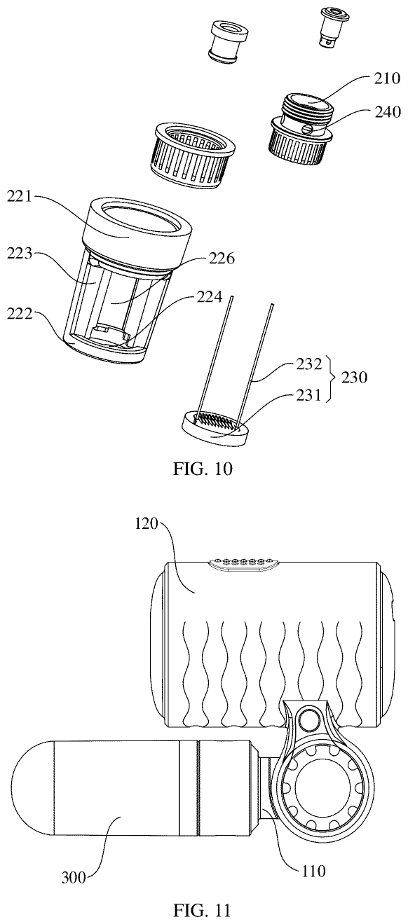

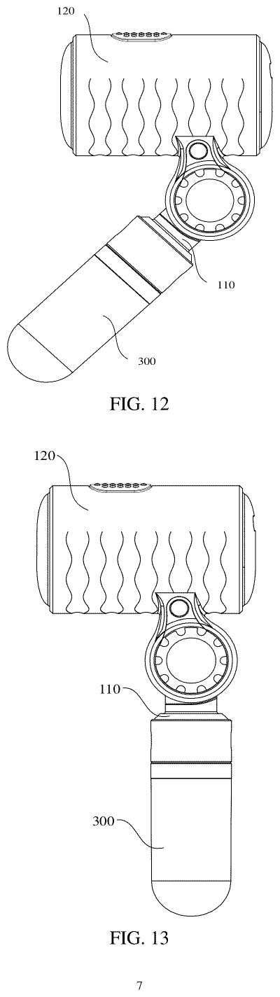

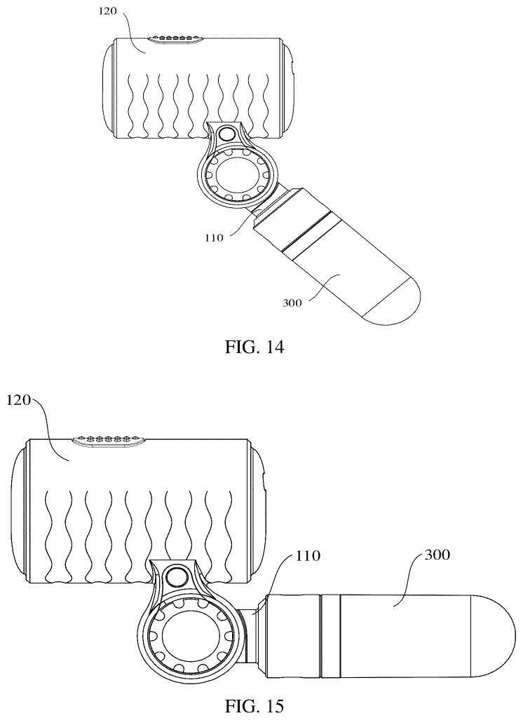

In an embodiment, as shown in FIG. 6 and FIG. 10, the atomizer core 200 includes a connector 210, an atomizer seat 220 and a heater 230. The connector 210 is connected to the atomizer seat 220, and the connector 210 is detachably connected to the mounting portion 111. The heater 230 is installed on the atomizer seat 220. The atomizer core 200 includes a connector 210 and an atomizer seat 220. The atomizer seat 220 is roughly cylindrical. The atomizer seat 220 is mainly configured to heat the atomized tobacco material to generate smoke for the user to inhale. The tobacco material can be a solid atomizer or a paste atomizer. The connector 210 is connected to the atomizer seat 220, and the mounting portion 111 is provided on the atomizer body 100. The connector 210 is also connected to the mounting portion 111. The connector 210 is respectively connected to the atomizer body 100 and the atomizer seat 220, and after the atomizer body 100 and the atomizer seat 220 are connected, the atomizer core 200 is electrically connected to the electronic control module. The connector 210 and the mounting portion 111 may be connected in a fixed manner, such as welding, gluing, or may be connected in a detachable manner, such as snap connection, screw connection, magnetic connection.

In an embodiment, as shown in FIG. 6 and FIG. 9, the heater 230 is installed at one end of the atomizer seat 220 away from the connector 210. When the atomizer 10 is connected to the water filter 20, firstly the atomizer seat 220 is inserted into one end of the adapter socket 21. Installing the heater 230 at the end of the atomizer seat 220 can ensure that there is enough space in the atomizer seat 220 to place the tobacco material. Moreover, the heater 230 is closer to the water filter 20, further shortening the smoke path. The heater 230 and the electronic control module are electrically connected, and the battery module supplies power to the heater 230, causing the heater 230 to generate heat and thus effectively atomize tobacco materials. The basic principle of the process is that the heater 230 generates heat under the power supply of the battery module, so that the tobacco oil and its dissolved substances around the resistance wire of the heater 230 volatilize, thereby forming smoke, so that the smoker can experience the effect of “puffing clouds and exhaling smoke”.

In an embodiment, as shown in FIG. 3 and FIG. 4, the connector 210 is detachably connected to the mounting portion 111. The atomizer core 200 is detachably connected to the atomizer body 100. Such a configuration facilitates the user to replace the atomizer core 200 as a whole. The detachable connection method may be a snap connection, a screw connection, or a magnetic connection. In the embodiment, in order to ensure the stability of the connection between the atomizer body 100 and the atomizer core 200, and to avoid the atomizer 10 being relatively separated from the water filter 20 due to unstable clamping when the user pulls the atomizer 10 out of the adapter socket 21 during use, the connector 210 and the mounting portion 111 can be connected by screw connection. The mounting portion 111 has an internal thread, and correspondingly, a stud may be provided on the connector 210. Or, the mounting portion 111 may be a stud protruding from the outer surface of the atomizer 10, and the connector 210 has an internal thread. The stud has an external thread.

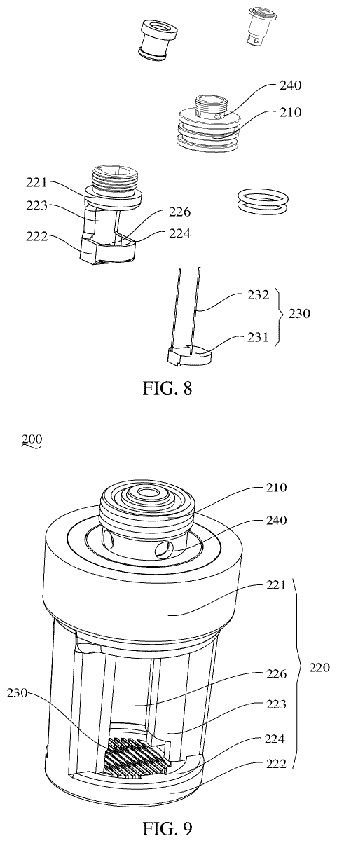

In an embodiment, as shown in FIG. 8 and FIG. 10, the heater 230 includes a heating portion 231 and a conductive portion 232 connected to the heating part. The heating portion 231 is provided on the chassis 222, and the conductive portion 232 is provided on the connecting portion 223 and electrically connected to the atomizer body 100. The heating portion 231 can be provided in a disc shape, and a resistance wire can be etched or directly provided on the disc, or it can be directly provided in a wire shape. The types and forms of the resistance wire are various to adapt to atomizer 10 products of different types and specifications. For example, a riveted resistance wire assembly, a welded resistance wire assembly, a simple winding resistance wire assembly, a spring coil assembly, a ceramic core resistance wire assembly, and a heating sheet heating assembly.

In an embodiment, during the use of the atomizer, the performance and quality of the resistance wire directly affect the atomization effect and taste of the atomizer. Therefore, high-quality resistance wire materials and exquisite production technology are one of the key factors to ensure the quality of the atomizer. At the same time, in order to maintain the best working condition of the atomizer, users also need to regularly check and replace the resistance wire to avoid problems such as excessive carbon deposition or aging that affect the use effect.

In an embodiment, as shown in FIG. 8 and FIG. 10, a discharge port 224 is provided on the circumference of the atomizer seat 220, and the discharge port 224 is configured to put tobacco into the atomizer seat 220. The outer peripheral wall of the atomizer seat 220 may be provided with a discharge port 224, so that the user can continue to fill tobacco material into the atomizer seat 220 after the tobacco material is used up. The atomizer core 200 can be configured as a disposable atomizer core 200, and the user can directly replace the entire atomizer core 200 after smoking, without filling tobacco, so the atomizer seat 220 does not need to be provided with a discharge port 224.

In an embodiment, the atomizer seat 220 includes an adapter 221, a chassis 222, and at least one connecting portion 223 connecting the adapter 221 and the chassis 222, and the discharge port 224 is formed in the connecting portion 223. The adapter 221 is configured to install the connector 210, and the chassis 222 is configured to install the heater 230. One end of the atomizer seat 220 is the adapter 221, and the other end of the atomizer seat 220 is the chassis 222. The adapter 221 is configured to install the connector 210 and realize a detachable connection with the atomizer body 100. The chassis 222 is configured to install the heater 230, and the adapter 221 and the chassis 222 are connected through the connecting portion 223. The quantity of the connecting portion 223 is at least one, which can be one, two, three or four, etc., and is not limited to this. If the quantity of the connecting portion 223 is set to multiple, the multiple connecting portions 223 are provided at intervals along the circumference of the atomizer seat 220. The cross sections of the chassis 222 and the adapter 221 are both circular, and the connecting portion 223 can connect the chassis 222 and the adapter 221, or may only connect a portion thereof. The discharge port 224 is formed on the connecting portion 223, which can be directly formed on the connecting portion 223 or formed on the outside of the connecting portion 223. The discharge port 224 can be directly opened on the connecting portion 223. The discharge port 224 can also be opened at a position between the chassis 222 and the connecting portion 223 that is not connected by the connecting portion 223.

In an embodiment, there are multiple installation forms for the connector 210 to be installed on the adapter 221. As shown in FIG. 10, the adapter 221 is provided with a recessed groove, and the connector 210 is installed in the recessed groove and has an interference fit with the recessed groove. As shown in FIG. 8, the adapter 221 is provided with a stud, and the connector 210 is provided with an internal thread. The connector 210 and the adapter 221 are threadedly connected.

In an embodiment, the outer wall of the connecting portion 223 is provided in an arc shape. Since the cross sections of the chassis 222 and the adapter 221 are both provided in a circular shape, and the connecting portion 223 connects the chassis 222 and the adapter 221, the cross section of the connecting portion 223 is provided in an arc shape. At the same time, the arc-shaped connecting portion 223 has a large contact surface area with the chassis 222, which can ensure the connection stability between the connecting portion 223 and the chassis 222. The arc-shaped connecting portion 223 also has a large contact surface area with the adapter 221, which can ensure the connection stability between the connecting portion 223 and the adapter 221. Furthermore, the inner wall of the connecting portion 223 is also provided in an arc shape, that is, in the cross section perpendicular to the axial direction of the atomizer seat 220, the cross section of the connecting portion 223 is provided in an arc shape.

In an embodiment, as shown in FIG. 8 and FIG. 10, the atomizer seat 220 has an atomizer material cavity 226, which is connected with the discharge port 224; the atomizer core 200 is provided with an air inlet 240, and the atomizer material cavity 226 is connected with the external environment through the air inlet 240. The atomizer seat 220 has an atomizer material cavity 226 for accommodating tobacco materials, and the atomizer material cavity 226 is communicated with the discharge port 224, so that when the user replenishes tobacco materials, he can directly place tobacco materials into the atomizer material cavity 226 through the discharge port 224. At the same time, an air inlet 240 is also provided on the atomizer core 200. The position of the air inlet 240 can be provided on the connector 210 of the atomizer core 200. The atomizer material cavity 226 is communicated with the external environment through the air inlet 240. When the user uses the atomizer 10, the user can suck the airflow in the external environment into the atomizer 10 through the air inlet 240 by sucking the nozzle of the atomizing device. The airflow flowing into the atomizer 10 will trigger the sensor in the atomizer 10, so that the atomizer core 200 starts to work and atomizes the tobacco material in the atomizer material cavity 226. The smoke generated after atomization flows into the water filter 20 and is inhaled by the user after filtration.

In an embodiment, as shown in FIG. 4 and FIG. 5, a step surface 225 is provided at the connection between the adapter 221 and the connecting portion 223. Since the atomizer 10 needs to be inserted as a whole into the adapter socket 21 of the water filter 20 when the atomizer 10 is assembled with the water filter 20. In order to prevent the atomizer core 200 from being inserted too deep, a step surface 225 is provided at the connection between the adapter 221 and the connecting portion 223. The step surface 225 has at least one limiting plane, and the insertion depth and the position of the atomizer core 200 after insertion are limited by the limiting plane of the step surface 225. In addition, a step surface 225 is provided at the connection between the adapter 221 and the connecting portion 223. The diameter of the adapter 221 is larger than the diameter of the connecting portion 223, and the outer wall surface of the adapter 221 is configured to seal and abut against the inner wall surface of the adapter socket 21 to ensure the sealing of the atomizer core 200 and the water filter 20.

In an embodiment, as shown in FIG. 6 and FIG. 10, in the direction from the adapter 221 to the chassis 222, the connecting portion 223 is flush with the outer surface of the chassis 222, and the connecting portion 223 is tapered. The connecting portion 223 is flush with the outer surface of the chassis 222 to ensure the flatness and smoothness of the outer wall of the atomizer core 200, and the outer surface of the connecting portion 223 is set to be tapered, which is convenient for the atomizer core 200 to be inserted into the adapter socket 21 of the water filter 20 as a whole.

In an embodiment, the adapter 221, the chassis 222 and the connecting portion 223 are integrally formed. Integral forming avoids welding or connection between components in traditional manufacturing, thereby eliminating seams and potential weaknesses. This helps to improve the strength and durability of the overall structure, because seams are often the most vulnerable places for components. Through integral forming, the material maintains continuity inside the component, which helps to better transfer and disperse stress, thereby improving the overall fatigue resistance and fracture resistance. In addition, integral forming can usually be completed in one processing process, reducing the need for multiple processes in traditional manufacturing. This not only saves time, improves production efficiency, but also reduces production costs. Integral forming technology is often combined with automated production equipment to further improve production efficiency and consistency. In addition, through precise molds and processing equipment, integral forming can ensure the size and shape accuracy of components and improve the overall appearance quality of the product. The integral forming setting also has significant advantages in reducing costs. On the one hand, integral forming reduces material waste caused by cutting, waste and reduces raw material costs; on another hand, due to the reduction of processes and the improvement of automation, integral forming also reduces dependence on labor and labor costs.

In an embodiment, as shown in FIG. 8, the quantity of the connecting portion 223 is one. One end of the connecting portion 223 is connected to the adapter 221, and the other end of the connecting portion 223 is connected to the chassis 222, and the outer side of the connecting portion 223 forms the discharge port 224. The adapter 221 and the chassis 222 are connected by one connecting portion 223, so that the opening of the discharge port 224 can be set larger, which is convenient for users to replenish tobacco materials through the discharge port 224.

In an embodiment, as shown in FIG. 6 and FIG. 7, the atomizer core 200 further includes a bottom plate 250, which is slidably connected to the chassis 222 and is located on a side of the heater 230 away from the connector 210. A gap is provided between the bottom plate 250 and the heater 230. Such an arrangement can prevent the heater 230 from falling down and becoming ineffective when subjected to external force, and the bottom plate 250 is configured to limit the heater 230. The bottom plate 250 is located on the side of the heater 230 away from the connector 210, that is, the bottom plate 250 is located below the heater 230. The bottom plate 250 partially blocks the bottom of the heater 230 to slow down the airflow, thereby ensuring that the heater 230 fully atomizes the tobacco material. At the same time, a gap is provided between the bottom plate 250 and the heater 230. If the tobacco material is solid or paste-like, the waste generated after the heater 230 atomizes the tobacco material can be retained in the gap, and will not fall into the water filter 20 to pollute the filtered liquid in the water filter 20.

In an embodiment, as shown in FIG. 7, a chamber 260 is formed between the bottom plate 250 and the heater 230. The atomizer seat 220 has a front side and a rear side opposite to the front side. The connecting portion 223 is provided at the rear side. The hatch of the chamber 260 is opened toward the front side. The left side and the right side of the hatch are respectively provided with end walls 270. The end walls 270 are provided from bottom to top and inclined from the rear side to the front side. The chamber 260 is formed by the gap between the bottom plate 250 and the heater 230. Waste generated after the heater 230 atomizes the tobacco material can fall into the chamber 260, and will not fall into the water filter 20 to pollute the filtered liquid in the water filter 20. The atomizer seat 220 has a front side and a rear side relative to each other, and the connecting portion 223 is provided on the rear side, the opening of the discharge port 224 is open to the front side, and the hatch of the chamber 260 is also opened to the front side. In this way, it is convenient for the user to take out the atomizer 10 after trial, directly pour out the remaining material in the atomizer material cavity 226 and the waste material in the chamber 260 in the same direction, and refill the atomizer material cavity 226 with new tobacco material.

In an embodiment, the end walls of the hatch of the chamber 260 are inclined from bottom to top and from the rear side to the front side. With such an arrangement, on the one hand, the hatch of the chamber 260 can be made larger, and on another hand, the larger hatch is convenient for the user to remove the bottom plate 250. The up and down direction described herein refers to the up and down direction of the atomizer 10 and the water filter 20 when they are assembled and used.

In an embodiment, as shown in FIG. 9 and FIG. 10, the quantity of connecting portion 223 is two, which are provided at intervals along the circumference of the atomizer core 200; one end of each connecting portion 223 is connected to the adapter 221, and the other end of each connecting portion 223 is connected to the chassis 222. A discharge port 224 is formed between the two connecting portions 223. The two connecting portions 223 are respectively provided on one side of the axis of the atomizer seat 220, and the two connecting portions 223 are symmetrically provided. A discharge port 224 is formed between the two connecting portions 223. The discharge port 224 has a large diameter, which is convenient for discharge, and there is no need to separately open the discharge port 224 on the connecting portion 223, which is convenient for production.

In an embodiment, the conductive part 232 is embedded in the connecting portion 223. Or, the connecting portion 223 is provided with a socket, and the conductive part 232 is inserted into the socket. The conductive part 232 of the heater 230 is configured to be electrically connected to the electric control module in the atomizer body 100, and the battery module is controlled by the electric control module to supply power to the heater 230 so that the heater 230 generates heat. The conductive part 232 can be directly embedded in the connecting portion 223 to be fixed by the connecting portion 223. Or a socket can be provided in the connecting portion 223, and the conductive part 232 is inserted into the socket of the connecting portion 223, so as to facilitate the installation of the heater 230.

In an embodiment, there are two conductive parts 232, which correspond to the positive and negative electrodes of the heater 230 respectively. One end of each conductive portion 232 is connected to the heater 230, and the other end of each conductive portion 232 is connected to the battery module, so as to conduct the power supply circuit between the battery module and the heater 230. For example, one end of a conductive portion 232 is connected to the positive electrode of the heater 230, and the other end is connected to the negative electrode of the battery module; one end of another conductive portion 232 is connected to the negative electrode of the heater 230, and the other end is connected to the positive electrode of the battery module. The contact point of the conductive part 232 of the atomizer core 200 adopts a threaded design, that is, one conductive part 232 is connected to the threaded structure of the connector 210, and another conductive part 232 is directly connected to the shell of the atomizer core 200. When the atomizer core 200 is screwed to the atomizer body 100, the threaded structure on the connector 210 also serves as the contact point of the positive electrode of the battery module. When the user installs or replaces the atomizer core 200, by rotating the atomizer core 200, it can be tightly connected to the contact point of the positive electrode of the battery module in the battery compartment, thereby achieving a closed loop circuit, so that the resistance wire is powered and generates heat. This design can enhance the stability of the connection, improve the conductivity, and facilitate installation and maintenance.

In an embodiment, the material of the atomizer seat 220 is a ceramic material. The ceramic material has the following advantages.

Firstly, high temperature resistance: the ceramic material can withstand high temperatures, which enables it to work stably in the atomizer 10 and will not be deformed or damaged due to high temperatures. When the atomizer 10 is working, the atomizer seat 220 needs to reach a certain temperature to atomize the smoke oil, and the high temperature resistance of the ceramic material ensures the smooth progress of this process.

Secondly, thermal conductivity: the ceramic material has fast thermal conductivity and can quickly transfer heat to the smoke oil to improve the atomization efficiency. This means that the user of the atomizer 10 can enjoy the smoke faster, and the taste and quality of the smoke will also be improved.

Thirdly, corrosion resistance and chemical stability: the ceramic material has good corrosion resistance and chemical stability, and can maintain its performance even in high temperature and complex chemical environments. This is very important for the atomizer 10, because the smoke oil may contain various chemical components, and the ceramic atomizer seat 220 can ensure that these components will not cause corrosion or damage to the atomizer seat 220.

Fourthly, safety: the ceramic material is non-toxic and harmless and will not release harmful substances into the smoke, thus ensuring the safety of the user of the atomizer 10. In addition, the stability of the ceramic material also reduces the risk of failure of the atomizer seat 220 during use, further improving the safety of the atomizer 10.

Fifthly, durability: the ceramic material has high hardness and wear resistance, which makes the ceramic atomizer seat 220 not easily damaged during long-term use, extending the service life of the atomizer 10. At the same time, the stability of the ceramic material also reduces the maintenance and replacement costs caused by damage to the atomizer seat 220.

Lastly, cleaning and maintenance: the surface of the ceramic material is smooth and not easy to absorb dirt and oil stains, which makes the ceramic atomizer seat 220 more convenient in cleaning and maintenance. Users can more easily remove the residue on the atomizer seat 220 to maintain the hygiene and performance of the atomizer 10. In summary, the ceramic material has the advantages of high temperature resistance, fast heat conduction, corrosion resistance, chemical stability, safety, durability, and easy cleaning and maintenance. These advantages make the ceramic material one of the ideal choices for the atomizer seat 220 of the atomizer 10. The ceramic material may be oxide ceramics, such as aluminum oxide ceramics, zirconium oxide ceramics, magnesium oxide ceramics, or non-oxide ceramics, such as silicon carbide ceramics, graphite ceramics, without specific limitation.

In an embodiment, as shown in FIG. 11 and FIG. 15, the atomizer body 100 includes a rotating part 110 and a main body 120. The mounting portion 111 is provided at one end of the rotating part 110, and the other end of the rotating part 110 is rotatably connected to the main body 120. The atomizer core 200 and the rotating part 110 are detachably connected. An electric control module, a battery module are provided in the main body 120. The main body 120 is rotatable relative to the rotating part 110. When the atomizer core 200 extends into the adapter socket 21 of the water filter 20, the user can freely adjust the direction or angle of the main body 120 as needed.

Further, the rotation angle of the rotating part 110 ranges from 0°-180°. The rotation angle of the rotating part 110 can reach up to 180°. Taking the axial direction of the main body 120 as the starting reference position, the rotation angle of the rotating part 110 relative to the reference position is ±90°.

In an embodiment, as shown in FIG. 1, the atomizer 10 further includes a protective cover 300, which covers the atomizer core 200. The protective cover 300 is configured to cover the entire atomizer core 200 when the atomizer core 200 is not plugged into the water filter 20 and placed separately, so as to protect the atomizer core 200 and prevent the atomizer core 200 from being contaminated by external impurities.

In technical solutions of the present application, the atomizer 10 includes an atomizer body 100 and an atomizer core 200. The atomizer body 100 is provided with a mounting portion 111. The atomizer core 200 includes a connector 210 and an atomizer seat 220. One end of the connector 210 is connected to one end of the atomizer seat 220, and the other end of the connector 210 is connected to the mounting portion 111. The atomizer core 200 is configured to extend into the adapter socket 21 of the water filter 20. By connecting the atomizer core 200 to the atomizer body 100 through the connector 210, the atomizer core 200 is located outside the atomizer body 100, and when the atomizer 10 is in use, the atomizer core 200 is partially extended into the adapter socket 21 of the water filter 20. The connection between the atomizer 10 and the water filter 20 does not need to pass through structures such as an air duct or an adapter, thereby shortening the smoke path, so that the smoke will not be lost due to the long path to the water filter 20. At the same time, the smoke will not condense and adhere to the inner wall of the air duct or the adapter, causing the air duct or the adapter to be blocked.

In an embodiment, the atomizer 10 applied to an atomizing device. The structure of the atomizer 10 refers to the above-mentioned embodiment. Since the atomizing device adopts all the technical solutions of all the above-mentioned embodiments, it at least has all the beneficial effects brought by the technical solutions of the above-mentioned embodiments, which will not be described one by one here. The atomizing device includes an atomizer 10 and a water filter 20. The atomizer 10 includes an atomizer body 100 and an atomizer core 200, and the atomizer body 100 is provided with an electric control module and a mounting portion 111. The atomizer core 200 includes a connector 210 and an atomizer seat 220, one end of the connector 210 is connected to one end of the atomizer seat 220, and the other end of the connector 210 is connected to the mounting portion 111. The atomizer core 200 is electrically connected to the electric control module, and the atomizer core 200 is configured to extend into the adapter socket 21 of the water filter 20.

The above contents are only some embodiments of the present application, and do not limit the scope of the present application. All equivalent structural changes made by using the contents of the present application specification and drawings under the inventive concept of the present application, or directly/indirectly applied in other related technical fields are included in the scope of the present application.

What is claimed is:

1. An atomizer, comprising:
an atomizer body; and
an atomizer core, wherein:
the atomizer body is provided with an electric control module and a mounting portion; and
the atomizer core is connected to the mounting portion and is located outside the atomizer body; the atomizer core is electrically connected to the electric control module, and the atomizer core is configured to extend into an adapter socket of a water filter.

2. The atomizer of claim 1, wherein the atomizer core comprises a connector, an atomizer seat and a heater; one end of the connector is connected to the atomizer seat, and the other end of the connector is detachably connected to the mounting portion; the heater is installed on the atomizer seat.

3. The atomize of claim 2, wherein the connector is threadedly connected to the mounting portion.

4. The atomizer of claim 2, wherein a discharge port is provided on a circumference of the atomizer seat, and the discharge port is configured to allow smoke material to be placed in the atomizer seat.

5. The atomizer of claim 4, wherein the atomizer seat is provided with an atomizer material cavity, and the atomizer material cavity is communicated with the discharge port; the atomizer core is provided with an air inlet, and the atomizer material cavity is communicated with an external environment through the air inlet.

6. The atomizer of claim 4, wherein the atomizer seat comprises an adapter, a chassis, and at least one connecting portion connecting the adapter and the chassis, and the discharge port is formed in the connecting portion; the adapter is configured to install the connector, and the chassis is configured to install the heater.

7. The atomizer of claim 6, wherein an outer wall of the connecting portion is provided in an arc shape.

8. The atomize of claim 6, wherein a step surface is provided at a connection between the adapter and the connecting portion.

9. The atomizer of claim 6, wherein in a direction from the adapter to the chassis, the connecting portion is flush with an outer surface of the chassis, and the connecting portion is tapered.

10. The atomizer of claim 6, wherein one connecting portion is provided; one end of the connecting portion is connected to the adapter, and the other end of the connecting portion is connected to the chassis; the discharge port is formed at an outer side of the connecting portion.

11. The atomizer of claim 10, wherein the atomizer core further comprises a bottom plate, and the bottom plate is slidably connected to the chassis and is located at a side of the heater away from the connector; and a gap is formed between the bottom plate and the heater.

12. The atomizer of claim 11, wherein a chamber is formed between the bottom plate and the heater, and the atomizer seat is provided with a front side and a rear side opposite to the front side; the connecting portion is provided on the rear side, and a hatch of the chamber is opened toward the front side; a left side and a right side of the hatch are respectively provided with end walls, the end walls are provided from bottom to top and inclined from the rear side to the front side.

13. The atomizer of claim 6, wherein two connecting portions are provided, and the two connecting portions are provided at intervals along a circumference of the atomizer core; one end of each connecting portion is connected to the adapter, and the other end of each connecting portion is connected to the chassis; the discharge port is formed between the two connecting portions.

14. The atomizer of claim 6, wherein the heater comprises a heating part and a conductive part connected to the heating part; the heating part is provided at the chassis, and the conductive part is provided at the connecting portion and electrically connected to the electric control module.

15. The atomizer of claim 14, wherein the conductive part is embedded in the connecting portion; or the connecting portion is provided with a socket, and the conductive part is inserted into the socket.

16. The atomizer of claim 2, wherein a material of the atomizer seat is ceramic material.

17. The atomizer of claim 1, wherein the atomizer body comprises a rotating part and a main body; the mounting portion is provided at one end of the rotating part, and the other end of the rotating part is rotatably connected to the main body.

18. The atomizer of claim 17, wherein a rotation angle of the rotating part ranges from 0°-180°.

19. The atomizer of claim 1, further comprising: a protective cover, wherein the protective cover is configured to cover the atomizer core.
